(19) United States
(12) Patent Application Publication
(10) Pub. No.: US 2026/0177716 A1
(43) Pub. Date: Jun. 25, 2026

(54) RESERVOIR WORKFLOW FRAMEWORK

(71) Applicant: Schlumberger Technology Corporation, Sugar Land, TX (US)

(72) Inventor: Andreas Laake, Hannover (DE)

(21) Appl. No.: 19/422,607

(22) Filed: Dec. 17, 2025

Related U.S. Application Data
(60) Provisional application No. 63/736,480, filed on Dec. 19, 2024.

(51) Int. Cl. G01V 1/30; G01V 1/00; G06F 11/34

(52) U.S. Cl. CPC G01V 1/30; G01V 1/003; G06F 11/3438

(57) ABSTRACT

A method can include can include tracking machine generated interactions with a computational framework to perform a workflow related to a reservoir, where the workflow generates output data using input data that characterizes the reservoir; identifying non-useful interactions that do not contribute to generation of the output data; generating a representation of the workflow that does not include the non-useful interactions; and storing the representation of the workflow to a workflow inventory.

### RELATED APPLICATIONS

This application claims priority to and the benefit of a U.S. Provisional Application having Ser. No. 63/736,480, filed 19 Dec. 2024, which is incorporated by reference herein in its entirety.

### BACKGROUND

A reservoir can be a subsurface formation that can be characterized at least in part by its rock properties such as porosity and permeability, and fluid properties such as viscosity and compressibility. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.). Various operations may be performed in the field to access such hydrocarbon fluids and/or produce such hydrocarbon fluids. For example, consider equipment operations where equipment may be controlled to perform one or more operations.

### SUMMARY

A method may include tracking machine generated interactions with a computational framework to perform a workflow related to a reservoir, where the workflow generates output data using input data that characterizes the reservoir; identifying non-useful interactions that do not contribute to generation of the output data; generating a representation of the workflow that does not include the non-useful interactions; and storing the representation of the workflow to a workflow inventory.

A system may include a processor; a memory accessible to the processor; and processor-executable instructions stored in the memory to instruct the system to: track machine generated interactions with a computational framework to perform a workflow related to a reservoir, where the workflow generates output data using input data that characterizes the reservoir; identify non-useful interactions that do not contribute to generation of the output data; generate a representation of the workflow that does not include the non-useful interactions; and store the representation of the workflow to a workflow inventory.

One or more computer-readable media may include processor-executable instruction that are executable to instruct a system to: track machine generated interactions with a computational framework to perform a workflow related to a reservoir, where the workflow generates output data using input data that characterizes the reservoir; identify non-useful interactions that do not contribute to generation of the output data; generate a representation of the workflow that does not include the non-useful interactions; and store the representation of the workflow to a workflow inventory.

A method may include receiving a task definition for a reservoir workflow that generates output data utilizing input data and a computational framework; responsive to the receiving, accessing an inventory of cleaned reservoir workflows and associated metadata; and recommending one of the cleaned reservoir workflows using a trained machine learning model and at least a portion of the task definition.

A system may include a processor; a memory accessible to the processor; and processor-executable instructions stored in the memory to instruct the system to: receive a task definition for a reservoir workflow that generates output data utilizing input data and a computational framework; responsive to the receipt of the task definition, access an inventory of cleaned reservoir workflows and associated metadata; and recommend one of the cleaned reservoir workflows using a trained machine learning model and at least a portion of the task definition.

One or more computer-readable media may include processor-executable instruction that are executable to instruct a system to: receive a task definition for a reservoir workflow that generates output data utilizing input data and a computational framework; responsive to the receipt of the task definition, access an inventory of cleaned reservoir workflows and associated metadata; and recommend one of the cleaned reservoir workflows using a trained machine learning model and at least a portion of the task definition.

Various other apparatuses, systems, methods, etc., are also disclosed. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates examples of equipment, an example of a network and an example of a system;

FIG. 3 illustrates an example of a process;

FIG. 4 illustrates an example of a workflow;

FIG. 5 illustrates an example of system;

FIG. 6 illustrates an example of a process;

FIG. 7 illustrates an example of a process;

FIG. 8 illustrates an example of an architecture;

FIG. 9 illustrates an example of an architecture;

FIG. 10 illustrates an example of an architecture;

FIG. 11 illustrates an example of a method and an example of a system;

FIG. 12 illustrates an example of a method and an example of a system; and

FIG. 13 illustrates examples of computer and network equipment.

### DETAILED DESCRIPTION

This description is not to be taken in a limiting sense, but rather is made merely for the purpose of describing the general principles of the implementations. The scope of the described implementations should be ascertained with reference to the issued claims.

### Example System

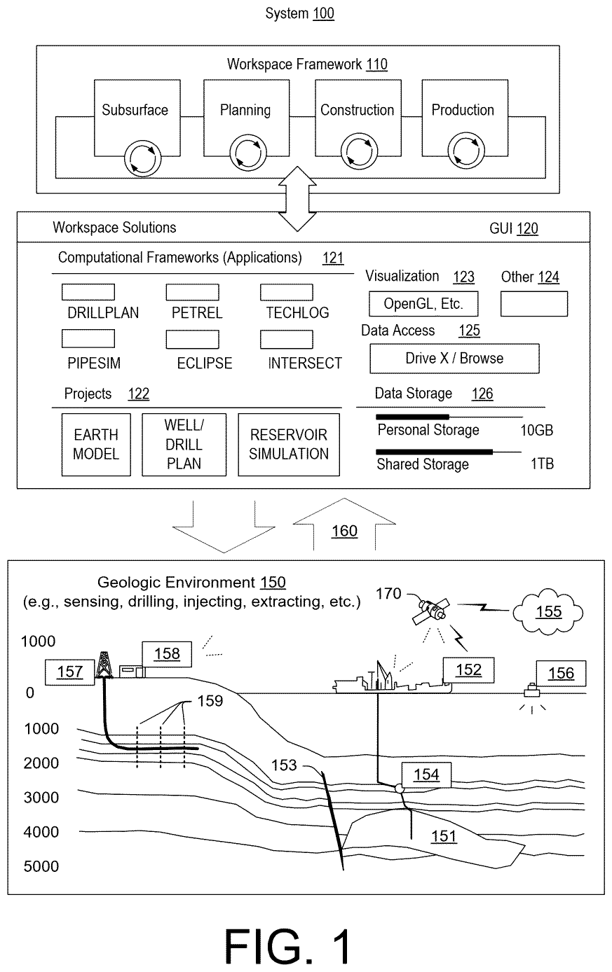

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite 170 in communication with the network 155 that may be configured for communications, noting that the satellite 170 may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). As an example, such an environment can provide for operations that involve one or more frameworks. The DELFI environment may be referred to as the DELFI framework, which may be a framework of frameworks. As an example, the DELFI environment can include various other frameworks, which can include, for example, one or more types of models (e.g., simulation models, etc.).

The TECHLOG framework can handle and process field and laboratory data for a variety of geologic environments (e.g., deepwater exploration, shale, etc.). The TECHLOG framework can structure wellbore data for analyses, planning, etc.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

As an example, the KINETIX framework (SLB, Houston, Texas) may be utilized, which provides for reservoir-centric stimulation-to-production analyses that can integrate geology, petrophysics, completion engineering, reservoir engineering, and geomechanics, for example, to provide for optimized completion and fracturing designs for a well, a pad, or a field. The KINETIX framework can be operatively coupled to and/or integrated with features of the PETREL framework (e.g., within the DELFI environment). As an example, the VISAGE framework (SLB, Houston, Texas) may be utilized, which may be part of or otherwise operatively coupled to the KINETIX framework.

The VISAGE framework includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO2 disposal, etc.

As an example, the KINETIX framework can provide for analyses from 1D logs and simple geometric completions to 3D mechanical and petrophysical models coupled with the INTERSECT framework high-resolution reservoir simulator and VISAGE framework finite-element geomechanics simulator. The KINETIX framework can provide automated parallel processing using cloud platform resources and can provide for rapid assessment of well spacing, completion, and treatment design choices, enabling exploration of many scenarios in a relatively rapid manner (e.g., via provisioning of cloud platform resources). The KINETIX framework may be operatively coupled to the MANGROVE simulator (SLB, Houston, Texas), which can provide for optimization of stimulation design (e.g., stimulation treatment operations such as hydraulic fracturing) in a reservoir-centric environment.

As an example, a platform, such as, for example, the LUMI platform (SLB, Houston, Texas) may be utilized. The LUMI platform includes features that provide for artificial intelligence solutions as may be integrated with data management capabilities. The LUMI platform provides for flexible deployment options and an open, secure, and modular architecture, for example, to empower data-driven decision-making. The LUMI platform is operable with the DELFI environment and, hence, one or more of various frameworks. While various platforms, environments, frameworks, libraries, etc., are mentioned, a framework may be operable in an agnostic manner, for example, to be compatible with one or more other platforms, environments, frameworks, libraries, technologies, etc.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.). While several simulators are illustrated in the example of FIG. 1, one or more other simulators may be utilized, additionally or alternatively.

In the example of FIG. 1, the visualization features 123 may be implemented via the workspace framework 110, for example, to perform tasks as associated with one or more of subsurface regions, planning operations, constructing wells and/or surface fluid networks, injecting fluid into a reservoir, and producing fluid from a reservoir. As an example, the visualization features 123 may be operable using one or more graphics frameworks, which may utilize, for example, one or more processors (e.g., CPUs, GPUs, etc.).

### Example System for Workflow Implementations

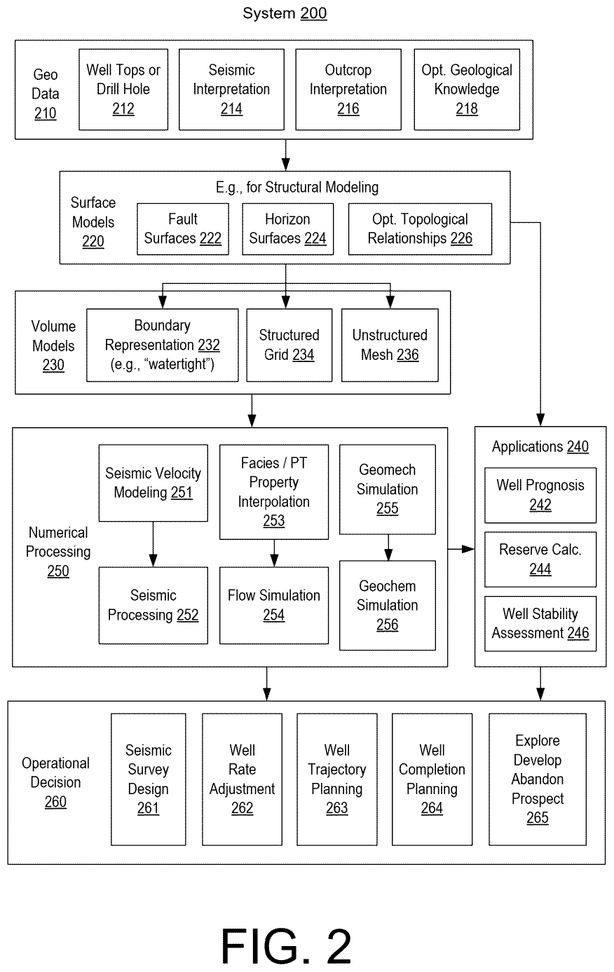

FIG. 2 shows an example of a system 200 that can be operatively coupled to one or more databases, data streams, etc. For example, one or more pieces of field equipment, laboratory equipment, computing equipment (e.g., local and/or remote), etc., can provide and/or generate data that may be utilized in the system 200.

As shown, the system 200 can include a geological/geophysical data block 210, a surface models block 220 (e.g., for one or more structural models), a volume models block 230, an applications block 240, a numerical processing block 250, and an operational decision block 260. As shown in the example of FIG. 2, the geological/geophysical data block 210 can include data from well tops or drill holes 212, data from seismic interpretation 214, data from outcrop interpretation 216 and optionally data from geological knowledge 218. As an example, the geological/geophysical data block 210 can include data from digital images, which can include digital images of cores, cuttings, cavings, outcrops, etc. As to the surface models block 220, it may provide for creation, editing, etc. of one or more surface models based on, for example, one or more of fault surfaces 222, horizon surfaces 224, and optionally topological relationships 226. As to the volume models block 230, it may provide for creation, editing, etc. of one or more volume models based on, for example, one or more of boundary representations 232 (e.g., to form a watertight model), structured grids 234, and unstructured meshes 236.

As shown in the example of FIG. 2, the system 200 may allow for implementing one or more workflows, for example, where data of the data block 210 are used to create, edit, etc., one or more surface models of the surface models block 220, which may be used to create, edit, etc., one or more volume models of the volume models block 230. As indicated in the example of FIG. 2, the surface models block 220 may provide one or more structural models, which may be input to the applications block 240. For example, such a structural model may be provided to one or more applications, optionally without performing one or more processes of the volume models block 230 (e.g., for purposes of numerical processing by the numerical processing block 250). Accordingly, the system 200 may be suitable for one or more workflows for structural modeling (e.g., optionally without performing numerical processing per the numerical processing block 250).

As to the applications block 240, it may include applications such as a well prognosis application 242, a reserve calculation application 244 and a well stability assessment application 246. As to the numerical processing block 250, it may include a process for seismic velocity modeling 251 followed by seismic processing 252, a process for facies and petrophysical property interpolation 253 followed by flow simulation 254, and a process for geomechanical simulation 255 followed by geochemical simulation 256. As indicated, as an example, a workflow may proceed from the volume models block 230 to the numerical processing block 250 and then to the applications block 240 and/or to the operational decision block 260. As another example, a workflow may proceed from the surface models block 220 to the applications block 240 and then to the operational decisions block 260 (e.g., consider an application that operates using a structural model).

In the example of FIG. 2, the operational decisions block 260 may include a seismic survey design process 261, a well rate adjustment process 262, a well trajectory planning process 263, a well completion planning process 264 and a process for one or more prospects 265, for example, to decide whether to explore, develop, abandon, etc. a prospect.

Referring again to the data block 210, the well tops or drill hole data 212 may include spatial localization, and optionally surface dip, of an interface between two geological formations or of a subsurface discontinuity such as a geological fault; the seismic interpretation data 214 may include a set of points, lines or surface patches interpreted from seismic reflection data, and representing interfaces between media (e.g., geological formations in which seismic wave velocity differs) or subsurface discontinuities; the outcrop interpretation data 216 may include a set of lines or points, optionally associated with measured dip, representing boundaries between geological formations or geological faults, as interpreted on the earth surface; and the geological knowledge data 218 may include, for example knowledge of the paleo-tectonic and sedimentary evolution of a region.

As to a structural model, it may be, for example, a set of gridded or meshed surfaces representing one or more interfaces between geological formations (e.g., horizon surfaces) or mechanical discontinuities (fault surfaces) in the subsurface. As an example, a structural model may include some information about one or more topological relationships between surfaces (e.g., fault A truncates fault B, fault B intersects fault C, etc.).

As to the one or more boundary representations 232, they may include a numerical representation in which a subsurface model is partitioned into various closed units representing geological layers and fault blocks where an individual unit may be defined by its boundary and, optionally, by a set of internal boundaries such as fault surfaces.

As to the one or more structured grids 234, it may include a grid that partitions a volume of interest into different elementary volumes (cells), for example, that may be indexed according to a pre-defined, repeating pattern. As to the one or more unstructured meshes 236, it may include a mesh that partitions a volume of interest into different elementary volumes, for example, that may not be readily indexed following a pre-defined, repeating pattern (e.g., consider a Cartesian cube with indexes I, J, and K, along x, y, and z axes).

As to the seismic velocity modeling 251, it may include calculation of velocity of propagation of seismic waves (e.g., where seismic velocity depends on type of seismic wave and on direction of propagation of the wave). As to the seismic processing 252, it may include a set of processes allowing identification of localization of seismic reflectors in space, physical characteristics of the rocks in between these reflectors, etc.

As to the facies and petrophysical property interpolation 253, it may include an assessment of type of rocks and of their petrophysical properties (e.g., porosity, permeability), for example, optionally in areas not sampled by well logs or coring. As an example, such an interpolation may be constrained by interpretations from log and core data, and by prior geological knowledge.

As to the flow simulation 254, as an example, it may include simulation of flow of hydrocarbons in the subsurface, for example, through geological times (e.g., in the context of petroleum systems modeling, when trying to predict the presence and quality of oil in an un-drilled formation) or during the exploitation of a hydrocarbon reservoir (e.g., when some fluids are pumped from or into the reservoir).

As to geomechanical simulation 255, it may include simulation of the deformation of rocks under boundary conditions. Such a simulation may be used, for example, to assess compaction of a reservoir (e.g., associated with its depletion, when hydrocarbons are pumped from the porous and deformable rock that composes the reservoir). As an example, a geomechanical simulation may be used for a variety of purposes such as, for example, prediction of fracturing, reconstruction of the paleo-geometries of the reservoir as they were prior to tectonic deformations, etc.

As to geochemical simulation 256, such a simulation may simulate evolution of hydrocarbon formation and composition through geological history (e.g., to assess the likelihood of oil accumulation in a particular subterranean formation while exploring new prospects).

As to the various applications of the applications block 240, the well prognosis application 242 may include predicting type and characteristics of geological formations that may be encountered by a drill bit, and location where such rocks may be encountered (e.g., before a well is drilled); the reserve calculations application 244 may include assessing total amount of hydrocarbons or ore material present in a subsurface environment (e.g., and estimates of which proportion can be recovered, given a set of economic and technical constraints); and the well stability assessment application 246 may include estimating risk that a well, already drilled or to-be-drilled, will collapse or be damaged due underground stress.

As to the operational decision block 260, the seismic survey design process 261 may include deciding where to place seismic sources and receivers to optimize the coverage and quality of the collected seismic information while minimizing cost of acquisition; the well rate adjustment process 262 may include controlling injection and production well schedules and rates (e.g., to maximize recovery and production); the well trajectory planning process 263 may include designing a well trajectory to maximize potential recovery and production while minimizing drilling risks and costs; the well trajectory planning process 264 may include selecting proper well tubing, casing and completion (e.g., to meet expected production or injection targets in specified reservoir formations); and the prospect process 265 may include decision making, in an exploration context, to continue exploring, start producing or abandon prospects (e.g., based on an integrated assessment of technical and financial risks against expected benefits).

The system 200 can include and/or can be operatively coupled to a system such as the system 100 of FIG. 1. For example, the workspace framework 110 may provide for instantiation of, rendering of, interactions with, etc., the graphical user interface (GUI) 120 to perform one or more actions as to the system 200. In such an example, access may be provided to one or more frameworks (e.g., DRILLPLAN, DRILLOPS, PETREL, TECHLOG, PETROMOD, ECLIPSE, INTERSECT, KINETIX/VISAGE, PIPESIM, etc.). One or more frameworks may provide for geo data acquisition as in block 210, for structural modeling as in block 220, for volume modeling as in block 230, for running an application as in block 240, for numerical processing as in block 250, for operational decision making as in block 260, etc.

As an example, the system 200 may provide for monitoring data, which can include geo data per the geo data block 210. In various examples, geo data may be acquired during one or more operations. For example, consider acquiring geo data during drilling operations via downhole equipment and/or surface equipment. As an example, the operational decision block 260 can include capabilities for monitoring, analyzing, etc., such data for purposes of making one or more operational decisions, which may include controlling equipment, revising operations, revising a plan, etc. In such an example, data may be fed into the system 200 at one or more points where the quality of the data may be of particular interest. For example, data quality may be characterized by one or more metrics where data quality may provide indications as to trust, probabilities, etc., which may be germane to operational decision making and/or other decision making.

### Example Workflow Processes

As explained, various types of workflows may be performed with respect to a reservoir, field operations, etc. In various instances, workflows involve acquisition of data, which can include data from one or more sources. For example, consider data from one or more databases, data from one or more sensors, data from equipment, etc. In various instances, data may include one or more of real data and synthetic data. As to synthetic data, such data may be generated using one or more simulators, which may include one or more physics simulators, one or more data-driven simulators (e.g., machine learning model-based, etc.), and/or one or more hybrid simulators (e.g., physics and data-driven, etc.). During a workflow, data may be utilized for one or more purposes, which may include generation of value-added data. For example, consider a control scheme where data may be utilized for purposes of controlling field equipment. In such an example, consider data that may include production data from a number of wells that may be utilized to control one or more types of field equipment (e.g., pumps, valves, separator, etc.).

As explained, a workflow may be performed using a computational framework, which may be local, remote, local and remote, etc. For example, such a framework may be referred to as an on-premises (on-prem) framework, a cloud-based framework, a distributed framework, etc. A framework may provide for human and/or machine interactions. For example, consider a framework that may generate one or more graphical user interfaces (GUIs) and/or include one or more other interfaces that may be interactive via one or more human-machine interfaces (HMIs) and/or via one or more machine-machine interfaces (MMIs). As an example, one or more workflows may involve framework interactions that occur with respect to time, which may occur with respect to one or more frameworks, one or more pieces of equipment, one or more humans, etc. As an example, interactions may occur in series, in parallel, in series and in parallel, etc.

As an example, a framework may provide for handling workflows that involve extracting information from input data and creating value-added output data. Such workflows may be computer-assisted processes that may include, for example, data processing, interpretation for energy discovery tasks, control, planning, monitoring, etc. Experts executing such workflows may utilize one or more types of computers, computing resources, executable code, HMIs, MMIs, etc., to execute tasks, which may be guided at least in part by expert experience (e.g., expert knowledge acquired by experience, etc.). Often, such workflows are not standardized, and, for example, they may include trials, run in loops, etc.

Capturing various aspects of a workflow transforming input data into output may be challenging and demand additional resources, as such, aspects of a workflow tend to be lost, unrecorded, and known to a user through the human nervous system. This implies that in most situations no recorded and reproducible audit trail from the output data back to the input data exists. For example, consider interpretation of seismic data for a subsurface environment where a user may interact with a framework that renders visualizations of data as such data are transformed from input to output. In such an example, the user may implement filters, generate attributes, etc., while observing output on a display until the user determines that an optimal result has been achieved (e.g., for purposes of identification of structural features, presence of hydrocarbons, etc.). Hence, a user may operate akin to a painter that selects a brush, mixes colors, etc., to achieve an optimal visual result. Such skill may be possessed by the user and may be challenging to capture and communicate to another or, at times, be challenging for the user to replicate exactly.

Given challenges in capturing or otherwise retaining framework interactions, a user may default to interactions that amount to repetition of trials for each new data set or even for the same data set when re-running one or more workflows. In various instances, a user may perform according to a trial-and-error approach where an action is performed to generate a result, the result assessed, and a determination made as to whether the result is appropriate or not. For example, a result may be desirable or undesirable. As to desirable, a result may be somewhat desirable but perhaps not as desirable as another result generated by a different action (e.g., an action, one or more parameters of an action, etc.). For example, consider an image analysis task that may involve utilization of one or more filters. In such an example, a GUI may include a menu for filter selection, which may allow for selection of a filter option individually or in combination with one or more other filters. Such a task may involve performing a number of trials where a result of each trial is visually assessed as to quality, which may be somewhat subjective and where each individual result is attempted to be stored within the user's memory. In such an example, a user may hone in on a filter type, filter types, filter parameter values, etc., until a best result is achieved within a reasonable amount of time, which may be a constraint. As an example, a framework may provide for improving upon such a trail-and-error approach through appropriate learning, which may conserve time, computational resources, etc.

As to a seismic data workflow, various types of filters, seismic attributes, etc., may be available for selection and implementation. As to filters, a filter may be a frequency-based filter (e.g., low-pass, high-pass, band-pass, etc.), a deconvolution filter, a velocity filter (e.g., an f-k filter, etc.), etc. As an example, a filter may use a kernel, which may be fixed or customizable. For example, consider an edge detection type of filter such as a Sobel filter that may utilize two kernels; noting that one or more other types of edge detection techniques may be available (e.g., Canny, Deriche, Differential, Prewitt, Robinson, Roberts cross, etc.). A subject matter expert (SME) with years of experience may be know what types of filters to consider and be able to predict results; however, even then, fine tuning of one or more filters via adjustable parameter values may still be quite time-consuming adding to workflow burden (e.g., consider setting and/or adjusting one or more filter parameter values using graphical fields, sliders, etc.). As explained, a framework that can leverage one or more learning techniques may help to expedite workflow performance, which may be in a manner that utilized fewer resources to achieve a more optimal result.

As to seismic attributes, in reflection seismology, a seismic attribute may be a quantity extracted or derived from seismic data that may lend itself to analysis to enhance information within the seismic data that might be more subtle in a traditional seismic image. Various seismic attributes may help lead to a better geological or geophysical interpretation of the data and, hence, an improved subsurface model for drilling operations (e.g., drilling a borehole to a reservoir, etc.). Some examples of seismic attributes may include measured time, amplitude, frequency and attenuation, in addition to combinations of such attributes. Various seismic attributes are post-stack, while some that use CMP gathers (e.g., amplitude versus offset (AVO)), tend to be analyzed pre-stack. As an example, a seismic attribute may be measured along a single seismic trace or across multiple traces within a defined region (e.g., 2D, 3D, 4D, etc.). As to some examples of seismic attributes of the PETREL framework, consider, for example, 3D Edge Enhancement Amplitude Contrast, Ant Tracking, Apparent Polarity Chaos, Consistent Curvature, Consistent Dip, Dip Guided Variance, Dip Illumination Directional Blending, Edge Evidence, Filter First Derivative, Generalized Spectral, Decomposition, Genetic Inversion, GLCM (grey-level, co-occurrence matrixes), Graphic Equalizer, Instantaneous Frequency, Instantaneous Phase, Local Flatness, Median, Phase Shift, Relative Acoustic Impedance, Remove Bias, RMS Amplitude (iterative), Second Derivative, Structural Smoothing, Structural Smoothing (e.g., Dip Guide, Edge Enhance), Sweetness, Time Gain, Trace AGC (iterative), and Variance (edge method).

Referring again to seismic data, consider a workflow that involves full waveform inversion (FWI). FWI provides for geotechnical site characterization and may be utilized in imaging arbitrarily heterogeneous compressional and shear wave velocity profiles of a subsurface environment. For example, a seismic survey may be performed that utilizes elastic waves to probe a site under investigation (e.g., by placing seismic vibrators on the ground surface, towing streamers from a vessel, etc.). Such waves propagate through a subsurface environment, and due to the heterogeneous geological structure thereof, multiple reflections and refractions occur. Data may be acquired, for example, using sensors such as accelerometers, geophones, etc. FWI may be performed using a framework that provides a computer model for simulation of elastic waves in a domain and an optimization procedure through which a computed response may be matched to a measured response, for example, via iteratively updating an initially assumed material distribution for the subsurface environment. An FWI workflow may involve a number of framework interactions where, for example, most of the time to create FWI output is spent performing trials to find an optimum parametrization for the FWI technique. In seismic interpretation, a workflow may involve selection of one or more picking techniques, which may have an impact on interpretation results. In such an example, the workflow may involve interactions that apply to global settings for picking as well as to local selection, for example, which event has been chosen for delineation of a horizon (e.g., a subsurface reflector, etc.). As explained, capture of each individual interaction of an executed workflow may be impractical and challenging due to the required time. Further, such capture may not even be sensible because there may be a number of unsuccessful trials and loops, which, if captured, may tend to mask portions of a workflow that meaningfully led to a desirable final result.

While an FWI workflow is mentioned as an example, various other types of workflows may involve one or more of parameter setting, iterations, loops, etc. For example, in the context of seismology, simulation of acoustic waves in a subsurface region may involve various interactions that may be performed by a user in order to achieve a desired result where the nature, type, amount, etc., of such interactions may depend on user experience with simulation, character of the subsurface region, etc.

In various instances, a workflow may be subject to constraints. For example, consider data constraints, time constraints, regulatory constraints, computational resource constraints (e.g., memory, compute power, etc.), etc. In various instances, a user may be limited in time and therefore unable to perform more than a few trials, which may lead to sub-optimal results. For example, consider a project that aims to characterize a reservoir where weather (e.g., land and/or marine conditions) may be a factor driving a deadline for results. In such an example, weather may be a factor as to surveying, drilling, completing, stimulating, etc. Hence, the best results achievable may be those that can be most efficiently achieved within a given time span. Such deadlines may have a psychological impact on users, for example, increasing hours per day, increasing strain (e.g., eye, hand, etc.), etc., which may also work against quality of results.

As an example, a workflow framework may provide for capturing framework interactions and generating streamlined framework interactions. As an example, such a framework may employ one or more technologies. For example, consider KVM, UEFI, video, sensor-based, etc., types of technologies. As an example, one or more technologies may be integrated with an operating system (OS) of a computing device, a baseboard management system of a computing device, etc. For example, a framework may provide for accessing one or more OS and/or other level functions of a computing device or computing system. As an example, a framework may provide for making application programming interface (API) calls to an OS and/or other circuitry-based system. In such an example, the framework may provide for establishing a channel for reporting of interactions that may be driven by one or more of human-machine interaction and machine-machine interaction.

In the WINDOWS OS family (Microsoft Corp., Redmond, Washington), a function SendInput function may be available and utilized to synthesizes interactions such as, for example, one or more of keystrokes, mouse motions, and button clicks. The WINDOWS OS family may also provide for use of a Raw Input API, for example, to provide raw input to an application (e.g., a framework, etc.) where such input may bypass message processing for lower latency and improved precision. As an example, a WINDOWS OS may provide for messaging, for example, consider WM_KEYDOWN and WM_MOUSEMOVE, which may provide for receiving input in a GUI app or apps via a message queue, which may be implemented in point-and-click types of interfaces, though with some amount of latency. As an example, a framework may provide for use of one or more technologies for accessing interaction data during a workflow.

As an example, a framework may employ click tracking. One implementation of click tracking involves cookies, which may be created when a user enters a certain word or clicks a certain button. In such an example, the cookies may be stored often on both the device the user is working on as well as on devices operated by a service provider that runs the cookies. Click tracking may involve measuring and reporting where an HMI interaction clicks or taps on a GUI (e.g., webpage, app, email, etc.). As an example, click tracking tools may provide for recording HMI device inputs (e.g., verbal, gesture, clicks, taps, etc.) and collect these data for one or more purposes. For example, consider assessing such data numerically, visually (heat maps), by individual sessions, etc. Such data may be indicative of framework interactions with particular features (e.g., graphics, scripts, libraries, etc.). As an example, such data may be measurements of user engagement, provide for spotting GUI errors, allow for identification of optimization opportunities, etc. While click tracking includes the term “click”, click tracking refers to tracking where an interaction may be an actual click such as a mouse button click or where an interaction may be another type of action (e.g., touch, keystroke, voice recognition, eye gaze, gesture, etc.). As an example, click tracking may involve tracking interactions using one or more types of input. For example, consider a microphone for speech recognition, a camera for eye gaze, a touchscreen for touch, a mouse for mouse movements and/or actuations, a keyboard for keystrokes, etc. As an example, a system may provide for capturing non-productive time (NPT), which may be recognized by one or more techniques. For example, if a user is uncertain as to an action, the user may navigate a mouse from one region of a GUI to another region, going back and forth, scrolling across a menu, etc. In such an example, time and/or movement without an action may be recorded and assessed to determine if this may represent a particular sticking point in a workflow as to a user making a proper decision. In such an example, if a user navigates between two choices, that may indicate that either choice may be OK, however, ultimately, one may be better than the other. As an example, where a close call may exist between multiple choices, a system may provide for issuing one or more notices as to possible options (e.g., different choices). As an example, a system may provide for implementation of one or more Pareto-based assessments where, for example, a trade-off between actions may exist (e.g., consider two paths with trade-offs and substantially equal outcomes, benefits, etc.).

As an example, a click tracking tool such as Hotjar (Hotjar Limited, Malta) may be utilized by a framework, which may provide tools for heatmaps and behavior analytics. Some examples of different types of click tracking may include email click tracking, link tracking, and UX click tracking. For example, email click tracking may allow for seeing how many people open emails and which links within them get clicked; link tracking may provide for monitoring and reporting link clicks; etc. As an example, UTM tracking code may be implemented for tracking links on websites and/or other GUIs.

As an example, click tracking technology may provide for security, such as, for example, anonymizing a user's personal data and keeping technical information to create the result. As an example, a framework may provide for capturing user data, for example, as may be associated with a role in an organization, years of experience, number of times a workflow has been performed, differences in performance of a workflow or workflows, etc. As an example, a framework may provide for discerning trends, for example, as to trials performed during a workflow. In such an example, number of trials may be related to user performance, problem complexity, data quality, etc. For example, considering seismic data, a workflow that utilizes seismic data of lesser quality may involve performing more trials in an effort to pull as much signal from noise, extrapolate or interpolate to data voids, etc.

As an example, an OS may provide for click tracking for one or more purposes, which may be leveraged for use by a framework. For example, consider an OS that employs click tracking for reliability monitoring to assess system stability, errors, and app crashes as may be related to one or more types of issues, health, etc. In such an example, a framework may provide for determining load on resources for particular interactions. For example, depending on how code may be written and/or executed along with links to circuitry (e.g., hardware for communications, rendering, etc.), a framework may rank various types of interactions with respect to demands placed on a computing device or computing system. As an example, a framework may provide for accessing and assessing performance demands on a computing device or computing system with respect to interactions. For example, consider access to system counters (e.g., CPU, memory, disk, etc.), trace events, activity logs, etc.

As an example, a framework may provide for implementation of a digital twin (DT). In such an example, a DT may be a digital equivalent to a physical twin (PT), which may be a physical workflow executed by a user of one or more computational frameworks. As an example, a DT may provide for capturing information about a PT in digital format, for example, by using metadata. As an example, digital metadata may be stored in a digital database, which, in turn, may be operated on by one or more digital machine learning (ML) and/or artificial Intelligence (AI) engines and processes. As an example, a DT approach may enable fast and comprehensive analysis of physical workflows and offers learning, efficiently, from past experience captured in DTs of physical workflows. As an example, a DT approach may utilize one or more virtualization technologies (e.g., consider one or more virtual machines, etc.).

As an example, a click tracker may be utilized as a hybrid automated tool that captures workflows, cleans them up (e.g., assisted by ML and/or AI) and proposes a cleaned workflow to a user for release upon which the workflow is stored in a digital inventory. As an example, a workflow stored in a digital inventory may be assessed with respect to one or more other workflows stored in the digital inventory. For example, consider a process that may provide for searching stored workflows for similarities and/or differences. In such an example, consider clustering stored workflows or otherwise classifying stored workflows, which may facilitate knowledge extraction, comparisons to standard operating procedures (SOPs), etc. As an example, such an approach may provide for intelligent provisioning of resources, instantiation of applications, etc., for workflow execution. For example, consider a stored workflow that may include one or more setup files that may be executed to expedite performance of the stored workflow.

As an example, a process of transforming input data to output data using a physical workflow may commence with the definition of the task to be achieved. Subsequently, the workflow to perform this task may be assessed. After completion of such preparation, a user may load input data and executes the workflow. In such an example, each interaction (e.g., click, etc., executed by the user) may be captured using digital tracking. Through such a process an initial DT of the physical workflow may be created. In various instances, such workflows may be executed with trials, errors, mistakes, loops, etc., which may be inefficient and do not contribute to a desirable result. While some trials, etc., may provide insight as to what to do next, they may, ultimately, have little to no effect on a desirable result. As an example, a framework may provide for identifying and extracting non-useful interactions, which may be characterized as being non-useful according to one or more criteria. As an example, criteria may consider whether an interaction resorted back to earlier data, actuated an “undo” function, proceeded forward and then backwards, etc. As an example, an analytics engine may be implemented to identify and extract one or more types of inefficient interactions. In such an approach, a framework may provide for generation of a clean workflow digital representation of useful portions of a physical workflow that had been executed by a user and/or a machine (e.g., via one or more HMIs, MMIs, etc.).

As an example, a framework may provide for generation of one or more GUIs for purposes of subject matter expert (SME) review, which may include validation, labeling, etc. For example, consider a framework that may provide for presentation of a clean workflow graphic and extracted interactions graphics that may readily allow an SME to discern what has been removed or otherwise altered to generate a clean workflow. In such an example, if an extracted interaction is actually a required interaction, though, perhaps, without effect on an end result, the SME may mark that extracted interaction to be retained. For example, consider an interaction that may pertain to security, regulatory, cost metrics, etc., which may be deemed required in one or more scenarios. In such an example, the framework may provide for marking the interaction for inclusion, which may be conditional inclusion. As to conditional inclusion, consider, for example, a geographic condition, a regulatory condition, an entity condition, etc., which may provide for condition checking upon execution of a workflow to determine whether or not the interaction is to be included in a workflow. In various instances, interactions for conditional inclusion may be relatively infrequent when compared to trials, etc., as may be indicative of user inexperience, user experience, user distraction, etc. In various instances, a user may take a break such as leaving work at night and returning the next morning. In such instances, upon return, the user may approach a workflow with fresh eyes or may need to refresh, which may result in increased efficiency or decreased efficiency, respectfully. As an example, a framework may note user breaks and assess interactions with respect to user breaks and, for example, break duration, etc.

As an example, a framework may provide for validation of a clean workflow (e.g., a cleaned workflow) that may be an appropriate representation of a workflow defined during task definition. As an example, if an SME considers that a clean workflow does not meet requirements defined by a task definition, the SME may send the digital workflow back to a workflow analytics process. As an example, if an SME approves a clean workflow, a framework may provide for storage of a DT of the physical workflow, for example, in a DT inventory.

As an example, a DT stored in a DT inventory may be subsequently used to send workflow metadata to output and merge it with physical output data thus providing appropriate information about processes that transformed input data into the physical output data. In such an example, the appropriate information may be information that provides for quality control and auditing of the physical output data.

As an example, information stored in a DT inventory may be used as a database against which a workflow assessment may be compared. For example, consider a comparison that may be carried out by a metadata comparison technique, an ML-based metadata check engine, etc. The result of a comparison may be a DT from a DT Inventory that is closest to a workflow defined in a task definition. In such an example, this workflow may then be proposed to a user and/or a machine of one or more frameworks for implementing the workflow, for example, as a starting point thus guiding the workflow execution efficiently.

### Example Process

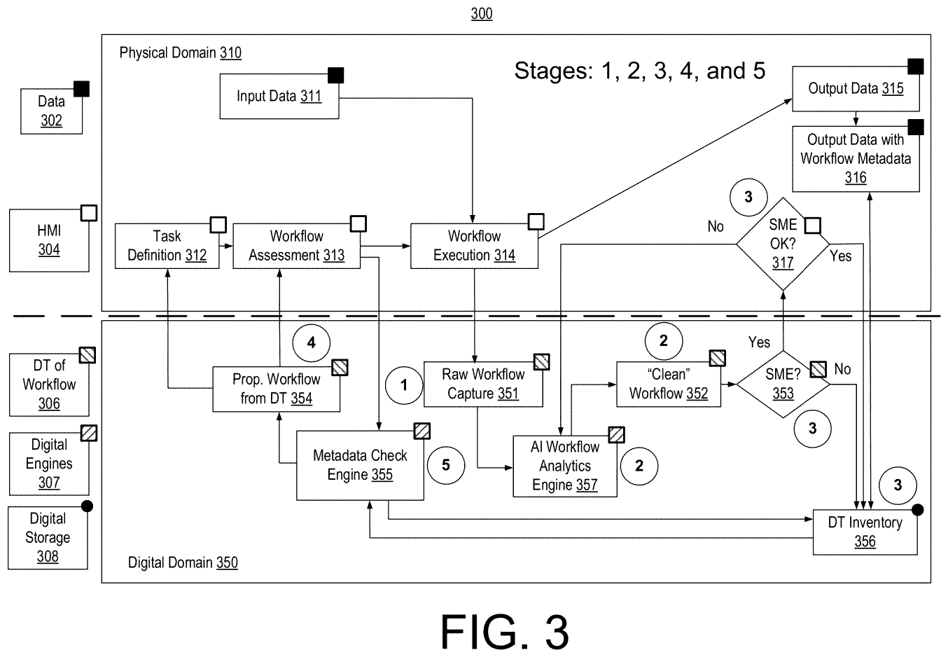

FIG. 3 shows an example of a process 300 where the process may be for implementation of a hybrid automated workflow capture and advice utilizing a DT approach. As shown in FIG. 3, the process 300 may involve a number of states, which may be denoted Stages 1, 2, 3, 4, and 5, which may utilize one or more components, blocks, etc., of a framework for execution. Below, example stages are described followed by descriptions of examples of framework components, blocks, etc.

As an example, in a first stage (e.g., Stage 1), a framework may transform a PT of user activity into a DT. For example, consider an approach that digitally tracks user activity from usage of executable code within a workflow (e.g., consider one or more frameworks for performing tasks, etc.). As explained, a click tracking technology may be implemented, which may include one or more features of one or more web applications that capture user activity.

As an example, in a second stage (e.g., Stage 2), a framework may run analytics on a DT, for example, consider executing an ML-based tool to identify one or more types of interactions (e.g., duplicates, deletes, errors and circular click sequences, etc.), which may be marked for cleaning (e.g., removal, etc.) and may be cleaned from a DT to generate a cleaned DT.

As an example, in a third stage (e.g., Stage 3), a framework may create a DT inventory, for example, by storing DTs of physical workflows (e.g., PTs) in a digital database. Such a process may be stage-gated by SME review, for example, using one or more GUIs, etc., which themselves may be amenable to click tracking as a type of workflow.

As an example, in a fourth stage (e.g., Stage 4), a framework may provide for guiding a PT of a workflow using one or more DTs from a DT inventory. For example, consider a search engine-based approach where, for example, keywords describing the purpose of a workflow may be utilized to search for and identify one or more DTs in a DT inventory. In such an example, the framework may propose to a user in the physical workflow to use the DT of the physical workflow at hand (e.g., as identified, etc.).

As an example, in a fifth state (e.g., Stage 5), a framework may Include performing ML in Stage 4. For example, consider using multiple physical workflows executing Stages 1 to 4 to train an ML model or ML models. In such an approach, a framework may run an ML model to generate a prediction and propose a resulting workflow DT to a user to execute a PT.

As an example, during one or more stages, a framework may operate to capture appropriate information about a workflow purpose, data input and output, usage parameters, results, etc., in metadata files, for example, consider JSON records. As an example, a framework may store these metadata records together with one or more DTs in digital storage. As an example, a framework may provide for performing one or more processes with localized (on premises) and/or cloud IT infrastructures.

In the example process 300, click tracking, as may be implemented in web search engines, may employ functionality of a first stage (e.g., Stage 1) and a quantification function of a second stage (e.g., Stage 2). As shown in FIG. 3, the process may be represented in a layer approach along with various specific layer components, such as, for example, a data component 302, an HMI component 304, a DT component 306, a digital engines component 307, and a digital storage component 308. These components are coded using markers, which include a filled square, an open square, two cross-hatched squares, and a filled circle, which also appear for various blocks.

As shown, layers or domains may include a physical domain 310 and a digital domain 350. In the example of FIG. 3, the digital domain 350 is shown as including a raw workflow capture component 351, a clean workflow component 352, a decision block 353, a proposed workflow from DT component 354, an ML-based metadata check engine 355, a DT inventory 356 (e.g., a data storage for DTs, etc.), and an AI workflow analytics engine 357. As shown, the decision block 353 of the digital domain 350 may include a corresponding decision block 317 in the physical domain 310.

As shown, input data, per an input data component 311, may be received for workflow execution where workflow execution may be guided by a task definition component 312 and a workflow assessment component 313. As to the workflow assessment component 313, it may be linked to features in the digital domain 350, for example, consider an approach where a proposed workflow is generated from a DT per the component 354, which may be in view of a task definition. As shown, the workflow assessment component 313 may provide output to a workflow execution component 314, which may output data per an output data component 315 and which may direct output to the metadata check engine 355, which may be an ML-based metadata check engine. As shown, the output data component 315 may be operatively coupled with an output data with workflow metadata component 316, which may be interactive with the DT inventory 356. As shown, a loop may exist between the physical domain 310 and the digital domain 350 that provides for generation of a proposed workflow from a DT per the component 354. For example, consider a scenario where the metadata check engine 355 may receive information from the workflow assessment component 313 to provide information to a DT to generate a proposed workflow per the component 354 (e.g., a proposed workflow from a DT).

As to generation of a clean workflow (e.g., a cleaned workflow), the digital domain 350 may capture raw workflow data per the component 351 (e.g., via one or more interfaces, etc.) where, for example, the AI workflow analytics engine 357 can provide for cleaning and/or otherwise tailoring, adjusting, etc., a workflow, for example, to generate a clean workflow per the component 352.

As explained, an SME may be involved in a process that can provide for making determinations as to workflows such as, for example, a clean workflow per the component 352 (e.g., consider an SME that may utilize an HMI to interact with a framework). As an example, if an SME approves a clean workflow per the component 352 using the decision block 317, the clean workflow may be stored in the DT inventory 356, which may be accessed by the metadata check engine 355. As shown, in various instances, a clean workflow per the component 352 may be stored in the DT inventory 356, without demand for an SME evaluation per the decision block 317 of the physical domain 310.

As explained, various machine-to-machine interactions may occur between the physical domain 310 and the digital domain 350. For example, consider one or more interfaces that allow for capture of actions, calling for execution of instructions, calling for rendering of one or more GUIs, calling for issuance of one or more notifications, calling for execution of a framework for performing a workflow, etc.

As shown, in the physical domain 310, upon execution of a workflow, output may be generated, which may be coupled with workflow metadata, as may be stored in the DT inventory 356. In such an approach, an audit trail and/or quality control data may accompany the output data. In such an approach, the output data may be reproducible according to the workflow metadata and/or one or more other workflow executions may select a clean workflow based at least in part on such workflow metadata. For example, a user may visualize the output data and find it acceptable and, accordingly, find the corresponding workflow acceptable for use in execution of workflow utilizing the same or similar data (e.g., from a common seismic survey, from a seismic survey that may be part of a 4D seismic survey, etc.).

### Example Workflow

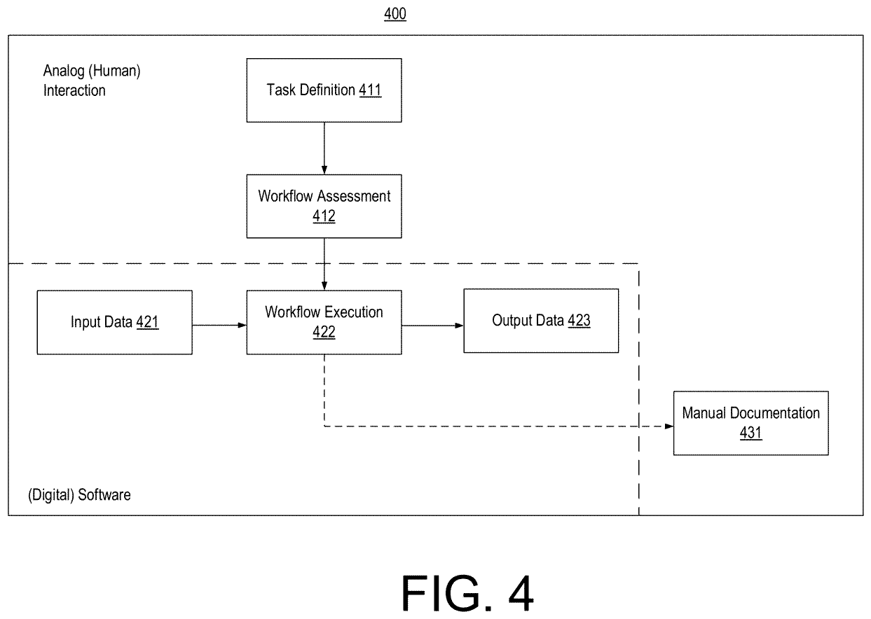

FIG. 4 shows an example of a relatively generic workflow 400 where human activity may be coupled with machine activity, for example, using a computing device, an HMI, etc. In the example of FIG. 4, a task definition 411 may be provided to a human for making a workflow assessment 412 where the human interacts with a machine for purposes of workflow execution 422 that utilizes input data 421 to generate output data 423. As shown, in the human realm, a human may document the workflow manually 431. For example, the human may write down various actions taken to instruct the machine (e.g., computer, workstation, etc.). As explained, such an approach may provide the user with notes that may or may not be suitable for selection and/or execution of a workflow for another task definition.

As an example, a reservoir related task may involve computer-assisted energy discovery, maturation and/or production workflows that may commence with a definition of a task to be performed which is followed by an assessment of the workflow that is designed to perform the task and turn the input data into the desired output data. In such an example, data, in this context, may mean any type of information and/or measurements in digital form. For example, data may include one or more of measured data, database entries, text, graphics, images, etc. Upon making a decision which workflow to use, the input data may be loaded, and the workflow executed for generating output data. To execute the workflow on a computer, a user may perform a sequence of actions that may involve a combination of keyboard entries, mouse or touchpad clicks, and/or results of other forms of interaction with the computer.

As an example, a click tracker technology may be implemented to capture each interaction of the user with a computer in raw workflows, which may then be fed into an automatic workflow analytics engine for analysis. Tasks of workflow analytics may include detection of unnecessary user interactions that had not ultimately been required to generate output data. Such unnecessary user interactions may include, for example, one or more of unsuccessful trials, loops and repeats (e.g., that may generate substantially unaltered results). As an example, workflow analytics may be implemented through utilization of one or more ML/AI technologies. As an example, a result of workflow analytics may be a cleaned workflow, for example, a workflow that includes non-extraneous user interactions.

As explained, a framework may operate in a digital domain to propose a cleaned workflow to a user, which may be for purposes of obtaining a release from the user. In such an example, the user may be an SME or another level of user where permissions, review, etc., may be required prior to making a clean workflow available via a DT inventory, etc. For example, if a user approves a release of the captured and cleaned workflow, then the workflow may be stored in a digital workflow library. However, if the user does not approve the release of the captured workflow, then workflow analytics may be re-run. Alternatively, a user may manipulate a cleaned workflow and release it. As explained, a GUI may be rendered for visualizing a workflow and/or one or more modifications whereby a user may interact with the workflow via the GUI to assure that it is suitable for subsequent use.

As an example, a framework may provide for accumulating a number of workflows for similar tasks in a workflow library, which may allow for workflow analytics to interrogate the workflow library prior to executing a cleanup task. With an increasing number of stored workflows, workflow analytics processes may become faster and more reliable leading to higher quality of one or more cleaning processes. For example, consider a learning approach whereby feedback from an SME may help guide training of one or more ML/AI technologies for automated workflow analytics processing.

As explained, a framework may provide for proposing or implementing workflows for execution by a machine, which may be guided by a human and/or another machine. In such an approach, a workflow may be optimized for execution to perform a task that transforms input data into output data.

As explained, a process may commence with the definition of a task (e.g., a task definition) that is to be performed by a workflow. Subsequently, a number of possible known workflows may be assessed, which, without automation, may depend on a personal meeting between SMEs and a project leader. Without automation, once a workflow and its deliverables are agreed upon, the user may commence the workflow by loading data into a computational framework (e.g., PETREL, etc.) and execute the workflow through a series of actions that are activated by mouse or touch screen clicks, etc. Once the workflow is completed, the user may store the output data and the user may generate, by-hand, some manual documentation separately to explain characteristics of the output data and how they were generated. Such a manual approach may be utilized to complement one or more machine-generated workflow captures. As an example, a machine learning approach may provide for automated documentation. For example, consider a trained ML model that may automatically generate documentation akin to what a user may generate manually. In such an example, a user may provide for tailoring output, which may be tailored by an ML model and/or post-ML model output. For example, consider an ML model that may generate output in a particular language that may be translated, stylized, formatted, etc., according to one or more preferences. As an example, a system may provide for generation of a digital workbook for a user such that a user may reference the digital workbook when planning to perform a workflow, when performing a workflow, when assessing results of a workflow, etc. As an example, a documentation database may be generated automatically, which may be specific to a framework, a user, a team, a company, a field, a type of asset, etc.

As explained, a non-automated or non-aided approach can be slow, error prone, and isolated largely to certain types of workflows that a user may already be familiar with (e.g., where a user has attained a high level of proficiency, expertise, etc.). As explained, manual documentation (e.g., hand-written notes) taken at the end, upon achieving desired results, often describe characteristics of the input and output data incompletely and may merely describe some parts of processes within a workflow where such manual documentation may not be physically linked to either the input data or the output data. In various instances, manual documentation is not created at all.

As explained, a framework may be implemented to address challenges associated with an analog workflow (see, e.g., FIG. 4). As explained, a DT approach may be implemented by a framework where a DT can be a digital representation of a physical process of executing a workflow in a computing environment, for example, where the framework can capture appropriate information in metadata, create a digital inventory of Digital Twins, and enable analytics based on the digital inventory.

### Example System

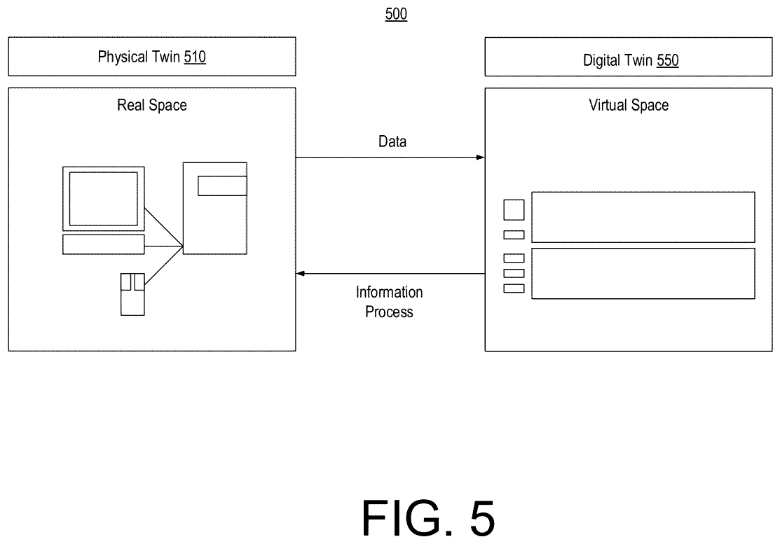

FIG. 5 shows an example of a system 500 that illustrates twins, including a physical twin (PT) 510 and a DT 550 in the context of executing a workflow using a computer (e.g., local, cloud, distributed, etc.). As indicated, the PT 510 includes a real space while the DT 550 includes a virtual space (e.g., as instantiated using hardware, executable code, etc.). In the example of FIG. 5, one or more interfaces may provide for transmission of data, which may include particular data, information process data, etc. As explained, interactions in the PT 510 may be captured in the DT 550.

As an example, a framework may provide for establishing a DT of one or more PTs. As an example, a DT may be structured for the task of executing a coded workflow transforming input data to output data and utilizing one or more ML/AI technologies for guiding a user through efficient and comprehensive analytics of the workflow. As explained, a framework may provide for generating a DT inventory, which can be a data store that stores various DTs. As an example, the digital twin 550 may provide for rendering of one or more graphical user interfaces (GUIs), for example, consider a GUI that includes one or more of the components of the process of FIG. 3, which may be represented as graphical controls that may be selectable or otherwise actuatable to cause a computing system to perform one or more tasks.

### Example Processes

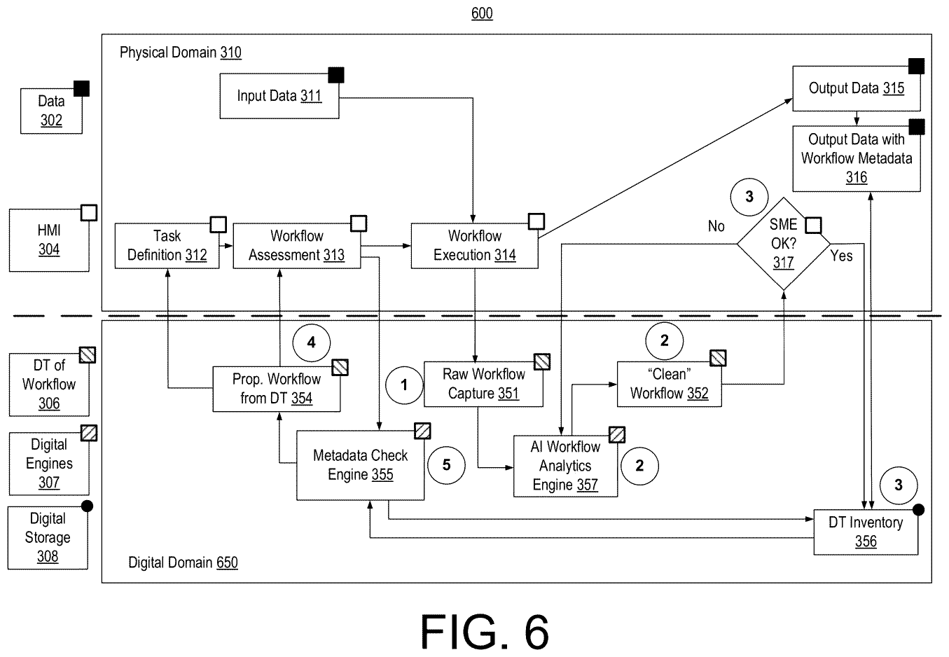

FIG. 6 shows an example process 600 that includes various features of the example process 300 of FIG. 3, however, the digital domain is labeled as digital domain 650. The example process 600 provides for illustration of a Stage 5 option where, for example, a metadata checker may be implemented that may utilize one or more routines, which may be advisable during creation of a DT inventory when an insufficient number of DTs may be available in a DT inventory. The process 600 may be a stage hybrid automated workflow capture and workflow execution advice process. In comparison to the example process 300 of FIG. 3, the example process 600 lacks the decision block 353 within the digital domain 350 of FIG. 3, while retaining the decision block 317 of the physical domain 310, which may decided whether an SME evaluation is required or not and/or whether an SME provided an OK, which may then provide for storage to the DT inventory 356, otherwise, the example process 600 may return to the analytics engine 357.

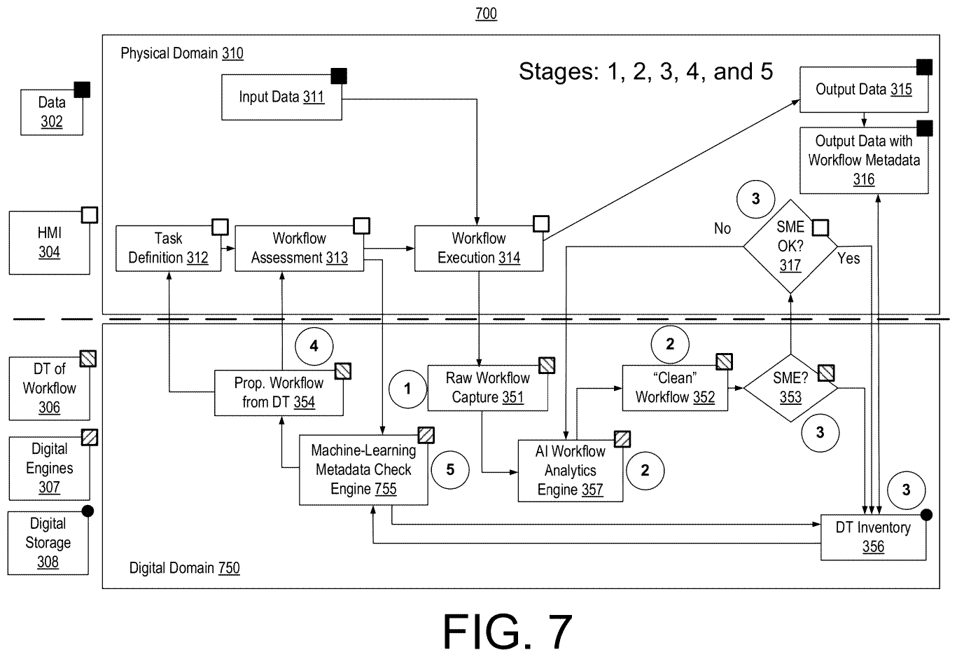

FIG. 7 shows an example process 700 that includes various features of the example process 300 of FIG. 3, however, the digital domain 350 is now labeled as a digital domain 750 where the metadata check engine 355 of FIG. 3 is now expressly a machine learning metadata check engine 755. The example process 700 provides for illustration of an ML-based approach to metadata checking per the engine 755, for example, as a Stage 5 option. As explained, a framework may provide for creation of one or more DTs where extraction and analysis of metadata may provide characteristics of objects to which they belong. For example, consider a digital domain that may implement a format such as the JSON format for handling of metadata records. In the example of FIG. 7, the machine learning metadata check engine 755 may include one or more trained ML models that have been trained for checking metadata and/or one or more unsupervised ML models that can provide for checking metadata. In such an approach, one or more aspects of metadata assessment, metadata generation, metadata adjustment, etc., may be implemented for a workflow as may be assessed per the workflow assessment component 313 where knowledge may be gleaned, for example, from the DT inventory 356. As an example, the process 700 may provide for utilization of click tracking for hybrid automated workflow capture and ML-based advice, which may provide for modification, customization, optimization, etc., of a workflow that may be represented in digital form, for example, as a digital twin (DT).

### Example Architectures

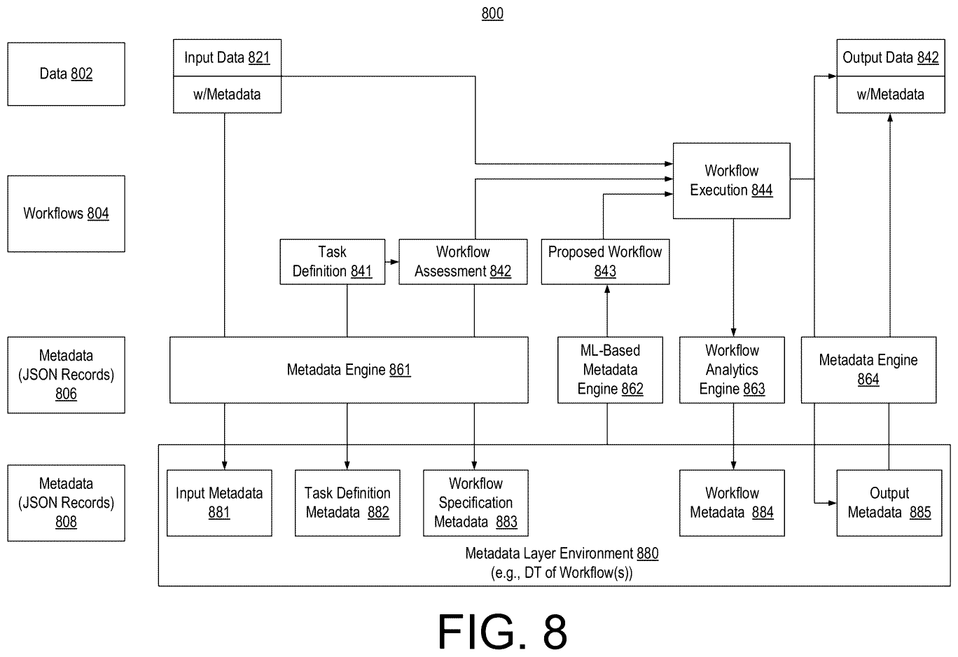

FIG. 8 shows an example architecture 800 for practical implementation of metadata flow for a hybrid workflow capture and advice using JSON records. In the example of FIG. 8, various layers are illustrated that can include a data layer 802, a workflows layer 804, a metadata layer 806 (e.g., JSON records, etc.), and a metadata layer 808 (e.g., JSON records, etc.). As shown, workflow execution can occur responsive to input 821 with metadata guided by a workflow assessment 842 that may utilize a task definition 841 where a proposed workflow 843 may be provided by an ML-based metadata engine 862. In such an example, the task definition 841 and the workflow assessment 842 may provide information to a metadata engine 861 that may also receive information from the input data 821. As shown, the metadata engine 861 may generate and/or extract input metadata 881, task definition metadata 882, and workflow specification metadata 883. Such types of metadata may be available in a DT workflow, as represented by the metadata layer environment 880 as associated with the metadata layer 808 where, as mentioned, the metadata may be in a format such as a JSON format (e.g., as JSON records, etc.). In the example of FIG. 8, the metadata layer 806 can interact with the metadata layer 808 for enhancing operation and/or performance of one or more workflows.

As shown in the example of FIG. 8, upon execution of the workflow 843 (e.g., the proposed workflow), workflow execution 844 (e.g., via a workflow execution engine, etc.) may output information to a workflow analytics engine 863 as output data 842 are generated. As shown, the workflow analytics engine 863 may provide for generation and/or extraction of workflow metadata 884 and a metadata engine 864 may provide for generation of output metadata 885, which may be associated with the output data 842. In the example of FIG. 8, the output data 842 may be enriched by being associated with one or more types of metadata (e.g., as may be provided by the metadata layer environment 880). As explained, metadata may be generated and/or extracted for purposes of auditing, quality control, reproducibility, optimization, training, etc.

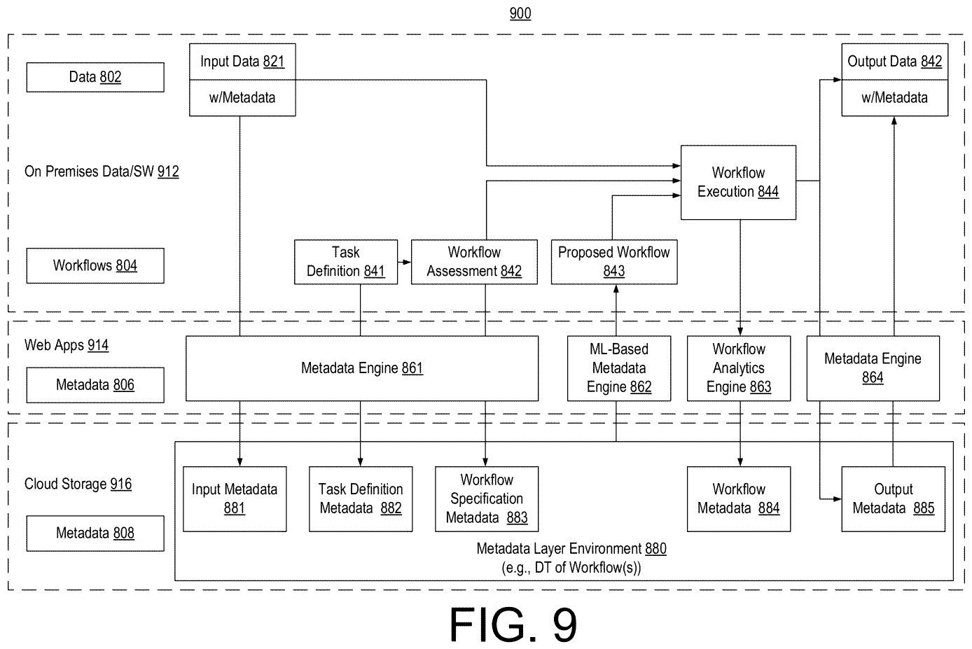

FIG. 9 shows an example of an architecture 900 that includes various layers, for example, consider the data layer 802, the workflow layer 804, the metadata layer 806, and the metadata layer 808. In such an example, the layers 802 and 804 may be in an on-premises data and framework environment 912 (e.g., PETREL, TECHLOG, etc.). As shown a web applications (web apps) environment 914 may provide for execution of operations of the metadata layer 806, while a cloud platform 916 may provide for execution of operations of the metadata layer 808 (e.g., for storage, management, access, searching, etc., of JSON records, etc.). As an example, a web applications environment may provide for bridging an on-premises environment and a cloud platform environment, where, for example, the web applications environment may provide for instantiation of one or more tracking technologies with respect to interactions occurring in the on-premises environment, as may be guided by interactions of the web applications environment with the cloud platform environment. In such an example, interactions, processes, etc., may be automated, semi-automated, etc., where, for example, actions may be performed in real-time or near real-time to improve operation and/or performance of workflows. As explained, a framework may provide for workflow enhancement via observation, learning, recommending, etc., which may occur in a manner that builds an inventory of DTs and that may enrich output with metadata.

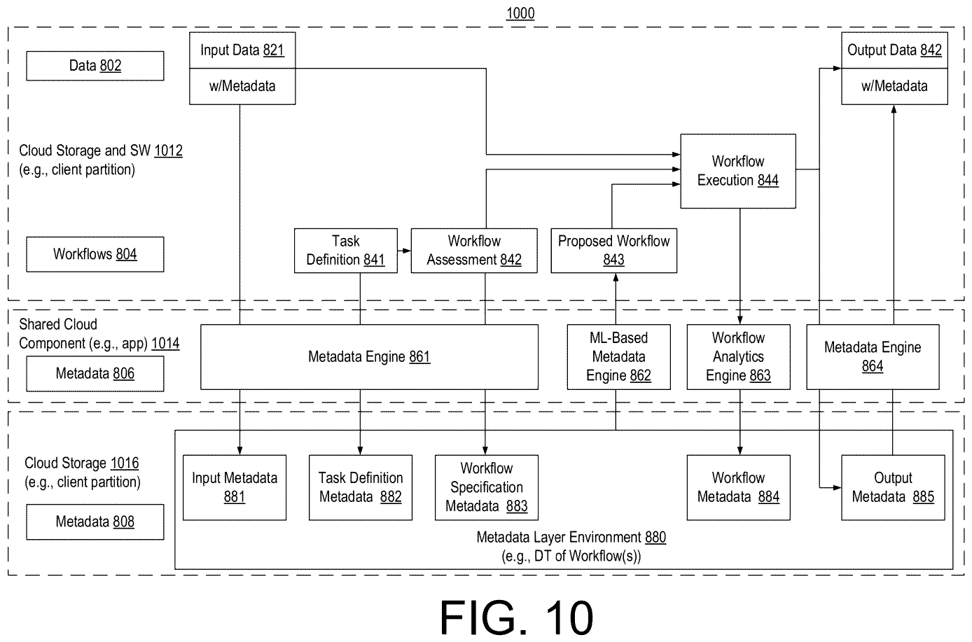

FIG. 10 shows an example of an architecture 1000 that includes various layers, for example, consider the data layer 802, the workflow layer 804, the metadata layer 806, and the metadata layer 808. In such an example, the layers 802 and 804 may be in a cloud platform environment 1012 that may be a client partition for storage and a framework environment (e.g., PETREL, TECHLOG, etc.). As shown a shared cloud platform environment 1014 may provide for execution of operations of the metadata layer 806, while a cloud platform storage environment 1016 (e.g., servers for accessing databases, etc.) may provide for execution of operations of the metadata layer 808 (e.g., for storage, management, access, searching, etc., of JSON records, etc.). In such an example, interactions, processes, etc., may be automated, semi-automated, etc., where, for example, actions may be performed in real-time or near real-time to improve operation and/or performance of workflows. As explained, a framework may provide for workflow enhancement via observation, learning, recommending, etc., which may occur in a manner that builds an inventory of DTs and that may enrich output with metadata.

As an example, a framework may be implemented using one or more computational devices, systems, etc., which may be operatively coupled via one or more networks (e.g., wired, wireless, etc.). As an example, one or more application programming interfaces (APIs) may be utilized where, for example, a call may be made according to an API where, in response, information is received. For example, consider one or more local and/or remote resources that may provide for use of one or more models that can be called according to one or more APIs. As an example, one or more APIs may be utilized to acquire data, control instructions, etc. As an example, one or more API technologies, techniques, etc., may be utilized (e.g., consider one or more REST APIs, etc.). As an example, an API may be suitable for human-machine interactions and/or machine-machine interactions. As an example, an API call may be automatically issued responsive to receipt of data, a trigger, a GUI interaction, etc., where, for example, a response may be automatically generated and transmitted (e.g., in a call and response manner, etc.). As an example, a framework may automatically perform one or more actions upon receipt of a response (e.g., an API response, etc.). As an example, a framework may be implemented using local and/or remote resources where, for example, local resources may include one or more types of edge devices installed locally at a wellsite for one or more wells. As to remote resources, consider one or more remote servers, cloud platform resources, etc. As an example, a framework may provide for provisioning of resources, for example, for execution of a workflow or workflows. For example, consider an approach where a streamlined workflow may be selected and resources provisioned for execution, which may be matched for performance of the streamlined workflow. In such an approach, resources may be conserved in comparison to use of a non-streamlined workflow. As an example, a framework may provide for improved utilization of provisionable computational resources, network traffic, etc. As an example, a framework may be implemented using one or more types of circuitry, which may include, for example, embedded circuitry. For example, consider embedding one or more components of a framework in a device, which may be a downhole device or a surface device.

As an example, a system, a method, etc., may utilize one or more machine learning features, which can be implemented using one or more machine learning models. As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, CATBoost, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, a system may utilize one or more recurrent neural networks (RNNs). One type of RNN is referred to as long short-term memory (LSTM), which can be a unit or component (e.g., of one or more units) that can be in a layer or layers. A LSTM component can be a type of artificial neural network (ANN) designed to recognize patterns in sequences of data, such as time series data. When provided with time series data, LSTMs take time and sequence into account such that an LSTM can include a temporal dimension. For example, consider utilization of one or more RNNs for processing temporal data from one or more sources, optionally in combination with spatial data. Such an approach may recognize temporal patterns, which may be utilized for making predictions (e.g., as to a pattern or patterns for future times, etc.).

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device and/or distributed devices may utilize LiteRT (formerly TENSORFLOW LITE) (Google LLC, Mountain View, California) or another type of lightweight framework. LiteRT is a set of tools that enables on-device machine learning where models may run on mobile, embedded, and IoT devices. LiteRT is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). LiteRT can provide multiple platform support, covering ANDROID and iOS devices, embedded LINUX, and microcontrollers. LiteRT can provide diverse language support, which includes JAVA, SWIFT, Objective-C, C++, and PYTHON. LiteRT can provide high performance, with hardware acceleration and model optimization.

### Example Methods and Systems

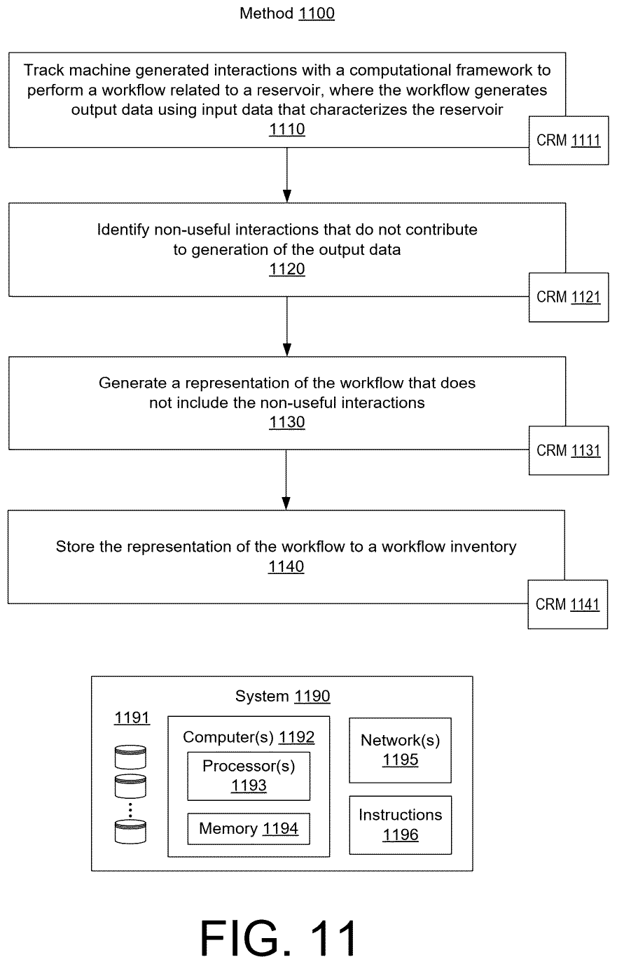

FIG. 11 shows an example of a method 1100 and an example of a system 1190. As shown, the method 1100 can include a tracking block 1110 for tracking machine generated interactions with a computational framework to perform a workflow related to a reservoir, where the workflow generates output data using input data that characterizes the reservoir; an identification block 1120 for identifying non-useful interactions that do not contribute to generation of the output data; a generation block 1130 for generating a representation of the workflow that does not include the non-useful interactions; and a storage block 1140 for storing the representation of the workflow to a workflow inventory.

The method 1100 is shown in FIG. 11 in association with various computer-readable media (CRM) blocks 1111, 1121, 1131, and 1141. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 1100. As an example, a computer-readable medium (CRM) may be a computer-readable storage medium that is non-transitory and that is not a carrier wave. As an example, one or more of the blocks 1111, 1121, 1131, and 1141 may be in the form processor-executable instructions.

In the example of FIG. 11, the system 1190 can include one or more information storage devices 1191, one or more computers 1192, one or more networks 1195 (e.g., network interfaces, etc.) and instructions 1196. As to the one or more computers 1192, each computer may include one or more processors (e.g., or processing cores) 1193 and memory 1194 for storing the instructions 1196, for example, executable by at least one of the one or more processors 1193 (see, e.g., the blocks 1111, 1121, 1131, and 1141). As an example, a computer may include one or more network interfaces (e.g., wired or wireless), one or more graphics cards, a display interface (e.g., wired or wireless), etc.

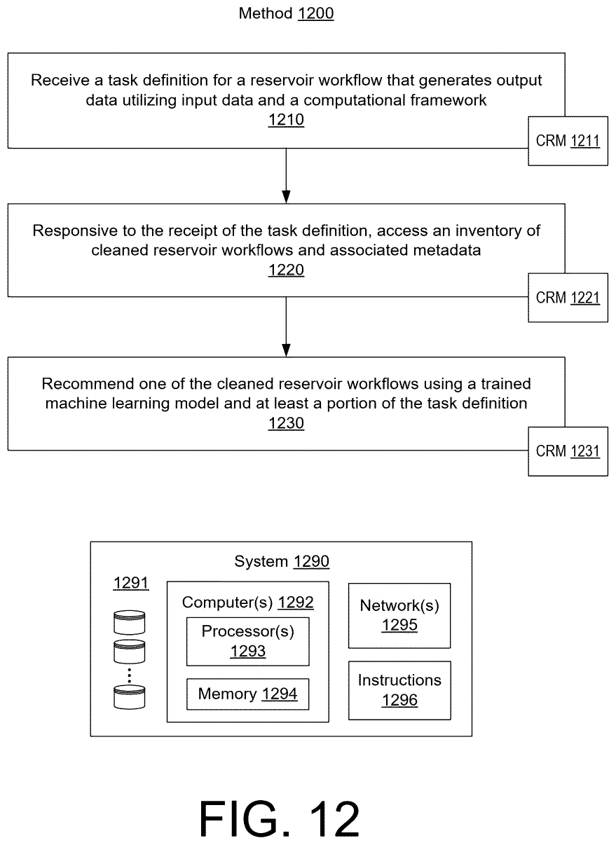

FIG. 12 shows an example of a method 1200 and an example of a system 1290. As shown, the method 1200 can include a reception block 1210 for receiving a task definition for a reservoir workflow that generates output data utilizing input data and a computational framework; an access block 1220 for, responsive to the receipt of the task definition, accessing an inventory of cleaned reservoir workflows and associated metadata; and a recommendation block 1230 for recommending one of the cleaned reservoir workflows using a trained machine learning model and at least a portion of the task definition. In such an example, the method may include an execution block for execution of the one of the cleaned reservoir workflows.

The method 1200 is shown in FIG. 12 in association with various computer-readable media (CRM) blocks 1211, 1221, and 1231. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 1200. As an example, a computer-readable medium (CRM) may be a computer-readable storage medium that is non-transitory and that is not a carrier wave. As an example, one or more of the blocks 1211, 1221, and 1231 may be in the form processor-executable instructions.

In the example of FIG. 12, the system 1290 can include one or more information storage devices 1291, one or more computers 1292, one or more networks 1295 and instructions 1296. As to the one or more computers 1292, each computer may include one or more processors (e.g., or processing cores) 1293 and memory 1294 for storing the instructions 1296, for example, executable by at least one of the one or more processors 1293 (see, e.g., the blocks 1211, 1221, and 1231). As an example, a computer may include one or more network interfaces (e.g., wired or wireless), one or more graphics cards, a display interface (e.g., wired or wireless), etc.

As an example, a method may include tracking machine generated interactions with a computational framework to perform a workflow related to a reservoir, where the workflow generates output data using input data that characterizes the reservoir; identifying non-useful interactions that do not contribute to generation of the output data; generating a representation of the workflow that does not include the non-useful interactions; and storing the representation of the workflow to a workflow inventory. In such an example, tracking may include implementing a click tracking technology, where machine generated interactions include human-to-machine interactions involving one or more human-to-machine interfaces.

As an example, input data may include seismic data acquired from a seismic survey of at least a portion of a reservoir. In such an example, output data may include interpreted data that identifies structural features of the reservoir.

As an example, non-useful interactions may include trial-and-error interactions as to one or more failed trials.

As an example, a method may include identifying by, at least in part, assessing one or more of time and computational resources spent on one or more non-useful interactions.

As an example, a method may include identifying by, at least in part, labeling one of a number of machine generated interactions as non-useful using one or more criteria. In such an example, the one or more criteria may include one or more of a loop criterion, a repetition criterion, a time criterion, a computational resources criterion, and a quality of output data criterion.

As an example, a method may include identifying that includes using one or more machine learning models that identify one or more non-useful interactions. In such an example, the method may include training at least one of the one or more machine learning models.

As an example, a method may include receiving a task definition and, based at least in part on the task definition, recommending a workflow from workflow representations stored in a workflow inventory. In such an example, the workflow inventory may be accessible via one or more technologies, techniques, etc. For example, consider a database system that may include search engine features, an application programming interface (API) that may provide for returning a result responsive to receipt of an API call that may include a task definition, etc.

As an example, a method may include receiving a task definition for a reservoir workflow that generates output data utilizing input data and a computational framework; responsive to the receiving, accessing an inventory of cleaned reservoir workflows and associated metadata; and recommending one of the cleaned reservoir workflows using a trained machine learning model and at least a portion of the task definition. In such an example, the method may include executing the one of the cleaned reservoir workflows. In such an example, the method may include capturing user interactions associated with the executing. In such an example, the method may include assessing the user interactions for non-useful interactions. In such an example, the method may include generating a revised cleaned reservoir workflow by removing one or more of the non-useful interactions. In such an example, the method may include storing the revised cleaned reservoir workflow to the inventory.

As an example, a method may include training a machine learning model to generate a trained machine learning model.

As an example, a system may include a processor; a memory accessible to the processor; and processor-executable instructions stored in the memory to instruct the system to: track machine generated interactions with a computational framework to perform a workflow related to a reservoir, where the workflow generates output data using input data that characterizes the reservoir; identify non-useful interactions that do not contribute to generation of the output data; generate a representation of the workflow that does not include the non-useful interactions; and store the representation of the workflow to a workflow inventory.

As an example, one or more computer-readable media may include processor-executable instruction that are executable to instruct a system to: track machine generated interactions with a computational framework to perform a workflow related to a reservoir, where the workflow generates output data using input data that characterizes the reservoir; identify non-useful interactions that do not contribute to generation of the output data; generate a representation of the workflow that does not include the non-useful interactions; and store the representation of the workflow to a workflow inventory.

As an example, a system may include a processor; a memory accessible to the processor; and processor-executable instructions stored in the memory to instruct the system to: receive a task definition for a reservoir workflow that generates output data utilizing input data and a computational framework; responsive to the receipt of the task definition, access an inventory of cleaned reservoir workflows and associated metadata; and recommend one of the cleaned reservoir workflows using a trained machine learning model and at least a portion of the task definition.

As an example, one or more computer-readable media may include processor-executable instruction that are executable to instruct a system to: receive a task definition for a reservoir workflow that generates output data utilizing input data and a computational framework; responsive to the receipt of the task definition, access an inventory of cleaned reservoir workflows and associated metadata; and recommend one of the cleaned reservoir workflows using a trained machine learning model and at least a portion of the task definition.

As an example, a computer program product can include one or more computer-readable storage media that can include processor-executable instructions to instruct a computing system to perform one or more methods and/or one or more portions of a method. Various example methods may be performed in various combinations.

### Example System

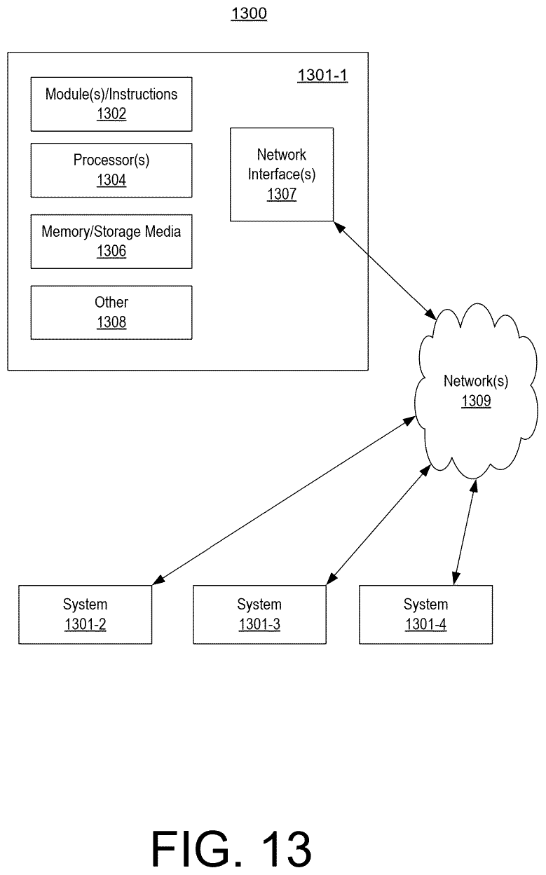

In some embodiments, a method or methods may be executed by a computing system. FIG. 13 shows an example of a system 1300 that can include one or more computing systems 1301-1, 1301-2, 1301-3, and 1301-4, which may be operatively coupled via one or more networks 1309, which may include wired and/or wireless networks. As shown, the system 1300 can include one or more other components 1308.

As an example, a system can include an individual computer system or an arrangement of distributed computer systems. In the example of FIG. 13, the computer system 1301-1 can include one or more modules 1302, which may be or include processor-executable instructions, for example, executable to perform various tasks (e.g., receiving information, requesting information, processing information, simulation, outputting information, etc.).

As an example, a module may be executed independently, or in coordination with, one or more processors 1304, which is (or are) operatively coupled to one or more storage media 1306 (e.g., via wire, wirelessly, etc.). As an example, one or more of the one or more processors 1304 can be operatively coupled to at least one of one or more network interface 1307. In such an example, the computer system 1301-1 can transmit and/or receive information, for example, via the one or more networks 1309 (e.g., consider one or more of the Internet, a private network, a cellular network, a satellite network, etc.).

As an example, the computer system 1301-1 may receive from and/or transmit information to one or more other devices, which may be or include, for example, one or more of the computer systems 1301-2, etc. A device may be located in a physical location that differs from that of the computer system 1301-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1306 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
tracking machine generated interactions with a computational framework to perform a workflow related to a reservoir, wherein the workflow generates output data using input data that characterizes the reservoir;
identifying non-useful interactions that do not contribute to generation of the output data;
generating a representation of the workflow that does not include the non-useful interactions; and
storing the representation of the workflow to a workflow inventory.

2. The method of claim 1, wherein the tracking comprises implementing a click tracking technology, wherein the machine generated interactions comprise human-to-machine interactions involving one or more human-to-machine interfaces.

3. The method of claim 1, wherein the input data comprise seismic data acquired from a seismic survey of at least a portion of the reservoir.

4. The method of claim 3, wherein the output data comprise interpreted data that identifies structural features of the reservoir.

5. The method of claim 1, wherein the non-useful interactions comprise trial-and-error interactions as to one or more failed trials.

6. The method of claim 1, wherein the identifying comprises assessing one or more of time and computational resources spent on the non-useful interactions.

7. The method of claim 1, wherein the identifying comprises labeling one of the machine generated interactions as non-useful using one or more criteria.

8. The method of claim 7, wherein the one or more criteria comprise one or more of a loop criterion, a repetition criterion, a time criterion, a computational resources criterion, and a quality of output data criterion.

9. The method of claim 1, wherein the identifying comprises using one or more machine learning models that identify one or more non-useful interactions.

10. The method of claim 9, further comprising training at least one of the one or more machine learning models.

11. The method of claim 1, further comprising:
receiving a task definition, and
based at least in part on the task definition, recommending a workflow from workflow representations stored in the workflow inventory.

12. The method of claim 1, comprising
receiving a task definition for a reservoir workflow that generates output data utilizing input data and a computational framework;
responsive to the receiving, accessing the inventory, wherein the inventory comprises cleaned reservoir workflows and associated metadata; and
recommending one of the cleaned reservoir workflows using a trained machine learning model and at least a portion of the task definition.

13. The method of claim 12, comprising executing the one of the cleaned reservoir workflows.

14. The method of claim 13, comprising capturing user interactions associated with the executing.

15. The method of claim 14, comprising assessing the user interactions for non-useful interactions.

16. The method of claim 15, comprising generating a revised cleaned reservoir workflow by removing one or more of the non-useful interactions.

17. The method of claim 16, comprising storing the revised cleaned reservoir workflow to the inventory.

18. The method of claim 12, comprising training a machine learning model to generate the trained machine learning model for recommending the one of the cleaned reservoir workflows.

19. A system comprising:
a processor;
a memory accessible to the processor; and
processor-executable instructions stored in the memory to instruct the system to:
track machine generated interactions with a computational framework to perform a workflow related to a reservoir, wherein the workflow generates output data using input data that characterizes the reservoir;
identify non-useful interactions that do not contribute to generation of the output data;
generate a representation of the workflow that does not include the non-useful interactions; and
store the representation of the workflow to a workflow inventory.

20. One or more computer-readable media comprising processor-executable instructions executable to instruct a system to:
track machine generated interactions with a computational framework to perform a workflow related to a reservoir, wherein the workflow generates output data using input data that characterizes the reservoir;
identify non-useful interactions that do not contribute to generation of the output data;
generate a representation of the workflow that does not include the non-useful interactions; and
store the representation of the workflow to a workflow inventory.
